(19) United States
(12) Patent Application Publication
(10) Pub. No.: US 2012/0091132 A1
(43) Pub. Date: Apr. 19, 2012

(54) PACKAGING AND METHOD FOR PACKAGING

(75) Inventor: Artur Eugeniusz Obolenski, Warszawa (PL)

(73) Assignee: Cadbury Holdings Limited, Uxbridge, Middlesex (GB)

(21) Appl. No.: 13/145,151

(22) PCT Filed: Jan. 12, 2010
(86) PCT No.: PCT/GB10/50033

§ 371 Date: Jan. 3, 2012

(30) Foreign Application Priority Data
Jan. 22, 2009 (GB) 0901041.4

(51) Int. Cl. B65D 6/00; B31B 1/26

(52) U.S. Cl. 220/6; 493/162

(57) ABSTRACT

A package for a block-shaped food product (15) comprises a sheet (10) of foldable material with an inner portion (16) for enclosing the product and a frame-shaped sealing portion (18) enclosing the inner portion for sealing the package. The sealing portion has opposing end sealing portions (20, 22) and opposing side sealing portions (24, 26). The sheet also has two flap portions (28, 30), one adjacent each of the side sealing side portions (24, 26). The sheet is folded around the product such that the inner portion (16) encloses the product with the inner surfaces of the two side sealing portions (24, 26) abutting to form a longitudinal seal and opposing inner surface regions of the end sealing portions (20, 22) abutting to form seals along respective ends. The inner and outer surfaces of the flap portions (28, 30) are accessible and one of the flap portions (30) is wider than the other (28). At least part of the longitudinal seal is folded over to one side so that the wider flap portion (30) is positioned underneath the narrower flap portion (28).

### TECHNICAL FIELD OF THE INVENTION

The present invention relates to packaging, and in particular to improved packaging for packaging generally block-shaped food products. The present invention is also directed to a method of packaging such food products.

### BACKGROUND TO THE INVENTION

It is known to package generally block-shaped food products, such as chocolate bars and other snack type confectionery products, in a wrapper that is fabricated from a material that is substantially gas and moisture impervious, in order to maintain the freshness of the product.

Such known wrappers comprise a sheet of flat, foldable material. The sheet is often rectangular and has an inner surface directed to the food product and an outer surface. The outer surface may be printed on or otherwise be provided with information for the consumer. An adhesive or a pressure sealable and re-sealable coating is applied to the inner surface of the sheet. The sheet is folded about the product so that an inner portion encloses the top, bottom, side and end surfaces of the product. The sheet is sufficiently long that it extends beyond the front and rear surfaces of the product and opposing inner surfaces of the sheet are brought into contact to form seals along the front and rear edges of the package. The inner surfaces of side portions of the sheet are also brought into contact to form a fin seal along the length of the package.

The known package forms a fully sealed package for the product, which is substantially gas and moisture impervious. However, because the material from which the sheet is made is quite tough, the known package can be difficult to open.

To address this problem, it has been proposed in GB 1, 107, 200 A to provided tabs along each of the sides of the sheet by folding the side edges of the sheet inwardly and sealing them in position. When the package is formed, the tabs project from an outer edge of the longitudinal fin seal. The inner and outer surfaces of the tabs are accessible by a consumer, who can grasp the tabs and pull them apart to open the package by pealing apart the longitudinal fin seal. However, it has been found that the tabs, which are of double thickness when compared to the remainder of the sheet, tend to jam when used in conventional packaging machinery.

An alternative proposal to the problem of opening the known packaging has been proposed in EP 1 288 139 A1. In this arrangement, the adhesive or pressure sealable and re-sealable coating is only applied to the inner surface in a frame-shape sealing portion surrounding the inner portion. The frame-shaped sealing portion has opposing end portions and opposing side portions. The sheet is also provided with a flap adjacent each of the side portions. In the finished packaging, the flaps project from an outer edge of the longitudinal fin seal. Both the inner and outer surfaces of the flaps are accessible such that they can be grasped by a consumer and pulled apart to open the package in a similar manner to the tabs. Because the flaps are the same thickness as the remainder of the sheet, this arrangement does not tend to jam in conventional packaging machinery. However, the flaps have been found to be not entirely satisfactory to consumers as a means of opening of the packaging.

It is an object of the invention to provide an improved packaging for a generally block-shaped product which overcomes or at least mitigates the above problems.

It is a particular object of the invention to provide a package for a generally block-shaped product which is conveniently opened and which can be applied to the product using conventional packaging machinery.

It is a further object of the invention to provide a method of packaging a generally block-shaped food product.

### SUMMARY OF THE INVENTION

In accordance with a first aspect of the invention, there is provided a package for packaging a generally block-shaped food product, the package comprising a sheet of foldable packing material having an inner surface and an outer surface, the sheet having an inner portion for enclosing the top, bottom, side, and end surfaces of the product, a frame-shaped sealing portion enclosing the inner portion for sealing the package and comprising opposing end portions and opposing side portions, and two flap portions, one flap portion being adjacent one side portion of the sealing portion and the other flap portion being adjacent the other of the side portions of the sealing portion, the sheet being folded around the product such that the inner portion encloses the block-shaped product with the inner surface of the sheet directed towards the product, the inner surfaces of the two side portions of the frame-shaped sealing portion abutting one another to form a longitudinal seal, opposing inner surface regions of the end portions of the frame-shaped sealing portions abutting each other to form seals along respective ends, in which the inner and outer surfaces of the flaps portions are accessible and one of the flap portions is wider than the other, at least part of the longitudinal seal and the flap portions being folded over to one side so that the wider flap portion is positioned underneath the narrower flap portion.

The provision of a wider flap portion underneath the narrower flap portion makes it easier for a user to see how the package can be opened by gripping the flap portions to pull them apart without having to lift the longitudinal fin seal.

The part of inner surface of the wider flap portion which is exposed beyond the outer edge of the narrower flap portion may carry instructions or graphics to guide the user on how to open the packaging.

At least the longitudinal seal may be formed by means of a sealing composition applied to the inner surface of the sheet within the sealing portion.

The sealing composition may be a peelable cold seal adhesive.

Sealing composition may not be applied to the flap portions.

The front and rear seals may be also be formed by means of a sealing composition applied to the inner surface of the sheet within the sealing portion. Alternatively, the front and rear seals may be formed by welding or otherwise fusing the opposing surfaces of the material in the sealing portion.

In accordance with a second aspect of the invention, there is provided a method of packing a generally block-shaped food product by means of a package in accordance with the first aspect, the method comprising:
a. positioning the inner surface of the inner portion of the sheet adjacent the food product;
b. folding the sheet around the product so that the product is enclosed by the inner portion of the sheet and the inner surfaces of the side portions of the seal portion are brought into abutment;
c. forming the longitudinal seal along the abutting area;
d. bringing opposing inner surfaces of the end portions of the sealing portion into abutment;
e. forming end seals in the abutting areas;
f. folding the longitudinal seal to one side so as to position the narrower flap portion above the wider flap portion.
   The sheet may be provided as part of a continuous roll and the package formed using a form-fill-seal packaging machine

### DETAILED DESCRIPTION OF THE INVENTION

An embodiment of the invention will now be described, by way of example only, with reference to the accompanying drawings, in which:

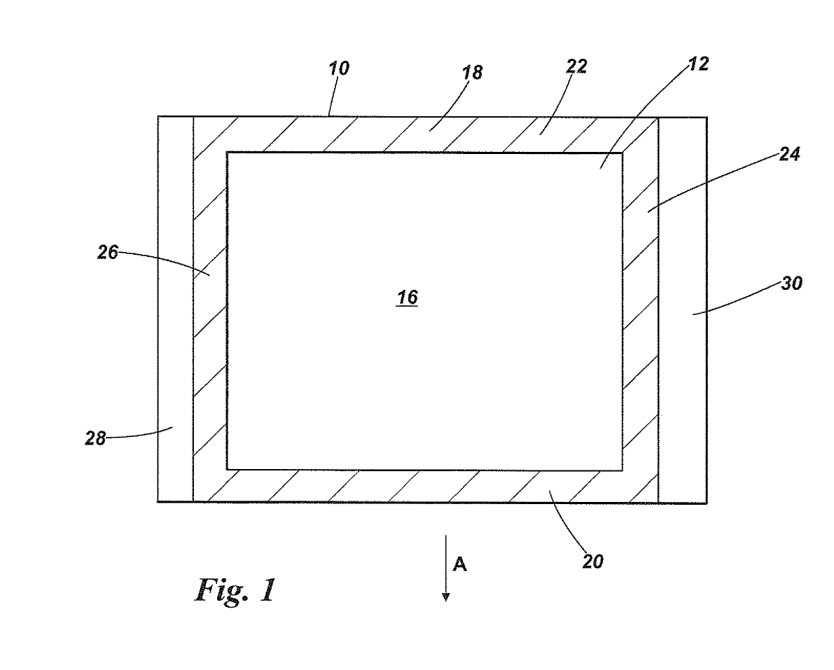

FIG. 1 is a schematic plan view of the inner surface of a sheet for forming a package in accordance with the invention;

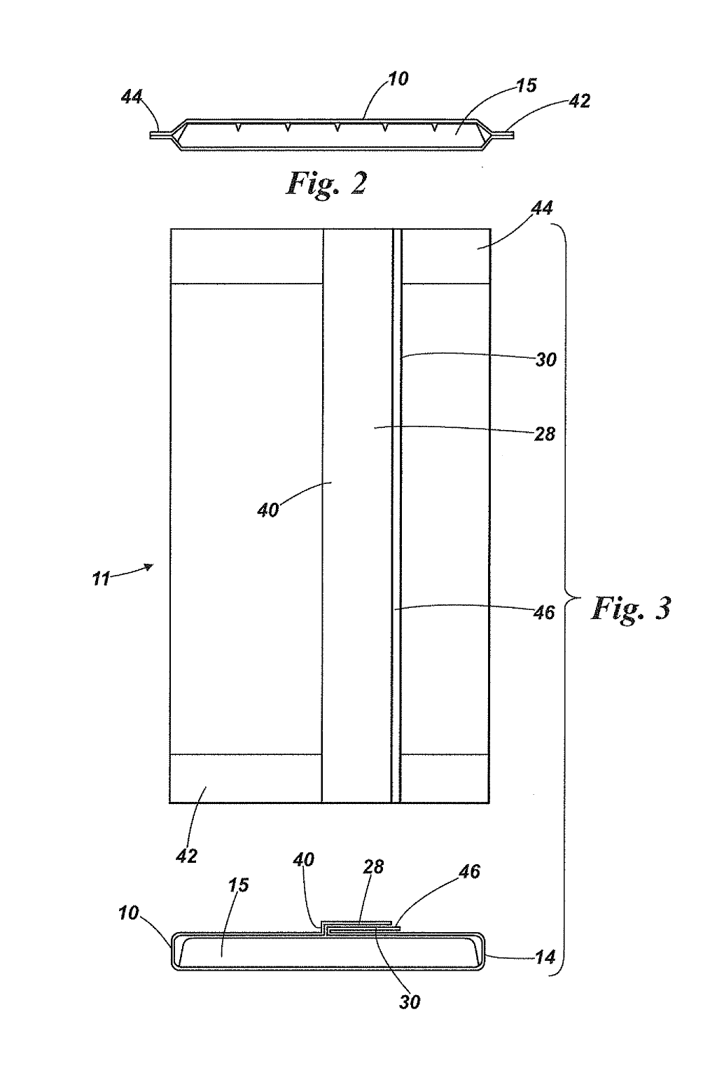

FIG. 2 is a longitudinal cross sectional view through a chocolate bar packaged in packaging in accordance with the invention;

FIG. 3 is a composite drawing showing a plan view of a rear surface of the completed packaging of FIG. 2 together with a corresponding lateral cross sectional view through the packaged chocolate bar; and

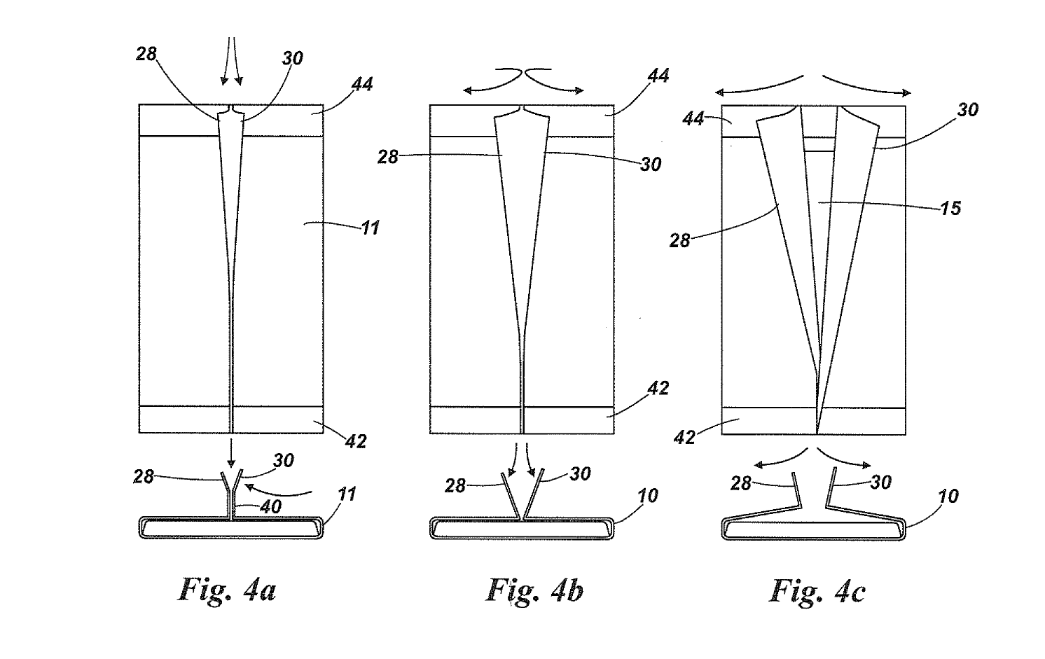

FIGS. 4a to 4c are composite drawings similar to FIG. 3 illustrating how the package is opened.

FIG. 1 shows schematically a flat sheet 10 of foldable material for forming a package 11 in accordance with the invention. The sheet can be made of any foldable material suitable for packaging food products. Preferably, the material is substantially moisture and gas impervious. For example, the sheet may be made of a paper based material, flexible films, one or more polymers, or a metallic foil. The sheet may also be a laminated sheet comprising layers of different materials, including any those mentioned above in any suitable combination. In one embodiment, the sheet comprises an orientated polypropylene (OPP) laminate. The sheet may be made from any of the materials discussed in the prior art patent applications discussed above, details of which are hereby incorporated by reference.

The sheet 10 has an inner surface 12 and an outer surface 14. The sheet has an inner portion 16 for enclosing the top, bottom, side, and end surfaces of a block-shaped food product. The food product may be a confectionery product and in particular a snack type confectionery product such as a chocolate bar.

Surrounding the inner portion 16 is a frame-shaped sealing portion 18 (indicated with cross hatching) The frame-shaped sealing portion is coated on the inner surface of the sheet with a sealing composition that enables a seal to be formed when opposing inner surface regions of the sealing portion 18 are contacted together during fabrication of the package. The composition may be a pressure sensitive coating which forms a seal upon the application of moderate pressure without the need to apply additional heat. The coating may be a sealable and re-sealable wax-like composition. Such a composition can be peeled apart to open the packaging but will re-seal if the surfaces are brought back into contact to re-close the package. The seal formed when the package is re-closed need not be as strong as the initial seal but will be sufficient to prevent the opposing surfaces from falling apart without the application of at least a minimal force to separate them. The sealing composition could, for example, be a pressure sensitive cold-seal adhesive or a self-adhesive thermoplastic material.

Alternatively, the sealing composition may be a temperature sensitive adhesive. The sealing composition may be any of those disclosed in the prior art patent applications discussed above, details of which are incorporated by reference.

The frame-shaped sealing portion 18 has a two opposing end portions 20, 22 and two opposing side portions 24, 26. When being applied to a blocked shaped food product, the sheet will be fed into a packaging machine in the direction of arrow A in FIG. 1. With reference to the direction of feed, the end portion 20 can be considered a front end portion and the end portion 22 can be considered a rear end portion. The corresponding ends of the product may also be considered as a front and rear end respectively. For the sake of convenience, the terms “front” and “rear” and “side” are used herein in relation to the direction of feed but should not be regarded as limiting.

The front and rear portions 20, 22 of the sealing portion 18 extend from respective front and rear edges of the inner portion 16 to the front and rear edges of the sheet 10 itself. Along one side of the sheet (the left as shown) the sheet extends beyond the outer edge of the side portion 26 to form a flap portion 28 on which no sealing composition is applied.

The sheet 10 also extends laterally outwardly from the outer edge of the other side portion 24 by a distance that is greater than the width of the flap 28 to form a wider flap portion 30. No sealing composition is applied to the wider flap portion 30.

To form the package 12, the food product 15 is located substantially centrally within the inner portion 16 so as to contact the inner surface of the sheet. The sheet 10 is then folded around the food product so that the inner surfaces of the side portions 24, 26 of the sealing portion 18 contact one another and a longitudinal seal 40 is then formed between the two side portions, typically by the application of a moderate pressure. With the sheet folded about the food product, the front and rear portions 20, 22 of the sealing portion 18 over hang the front and rear ends of the product respectively and are folded back over themselves so that opposing regions of the inner surface of the front and rear portions are in contact. Front 42 and rear 44 seals are formed, typically by the application of a moderate pressure to the front and rear sealing portions.

The product is now sealed inside the package 12 by virtue of the front 42, rear 44 and longitudinal 40 seals. The flap portions 28, 30 project from the free end of the longitudinal seal and the inner and outer surfaces of the flap portions are accessible as they are not bonded together. As shown in FIG. 3, the longitudinal seal 40 and the two flap portions 28, 30 are folded over to one side so as to lie generally parallel to the surface of the product.

In accordance with the present invention, the longitudinal seal 40 is folded about a fold line so that the wider flap portion 30 is underneath the narrower flap portion 28 so that an end portion 46 of the wider flap projects beyond the free end of the narrower flap portion 28. With the longitudinal seal folded over in this manner, a consumer can easily see the two flap portions 28, 30 and recognise that these can be grasped to open the package, without having to lift the longitudinal fin seal. In addition, graphics or text may be applied to sheet to make the method of opening clear and to provide instruction. At least some of the graphics and/or text may be applied to the portion 46 of the inner surface of the wider flap portion 40 which is exposed beyond the outer edge of the narrower flap portion 28 when the fin seal is folded over.

FIGS. 4a to 4c illustrate how the package is opened by lifting the fin seal 40, grasping the flap portions 28, 30 which are not bonded and pulling them apart as indicated by the arrows. To further assist a consumer in opening the package, an embossed pattern may be applied to all or part of the flap portions 28, 30.

The package 12 is typically formed in a form-fill-seal (FFS) packaging machine and the sheet 10 is preferably provided as part of a continuous roll of sheets (roll-fed) fed into the machine in the direction of arrow A. The material is folded about each product in turn so that opposing side regions 24, 26 of the sealing portion are brought into contact and bonded together to form the longitudinal seam 40, opposing end regions 20, 22 of sealing portion at either end of the product are brought into contact and bonded to form the transverse end seams 42, 44 and the material is cut to separate the package from the remainder of the film. The longitudinal seal 40 and the flap portions 28, 30 are folded over at any suitable stage in the process.

The sealing composition may be pre-applied to the sheets or roll or it may be applied during formation of the package.

In an alternative embodiment, at least the end seals may be welded without a sealing composition. Welding can be carried by any suitable means and may involve heating the material in the sealing portion under pressure so that the opposing surfaces melt and fuse together to form a welded seam. For example, the end seals may be welded seals and the longitudinal seal may be formed by means of a peelable and re-sealable composition applied to the material.

Various changes and modifications may be made to the above described package without departing from the scope of the present invention as defined in the claims. For example, in the embodiments illustrated, the sheet 10 is rectangular and is suitable for packaging a rectangular block-shaped food product. However, the shape and dimensions of the sheet 10 can be varied to suit the shape and dimensions of the product which could be a square generally block-shaped product, for example.

1. A package for packaging a generally block-shaped food product, the package comprising a sheet of foldable packing material having an inner surface and an outer surface, the sheet having an inner portion for enclosing the top, bottom, side, and end surfaces of the product, a frame-shaped sealing portion enclosing the inner portion for sealing the package and comprising opposing end portions and opposing side portions, and two flap portions, one flap portion being adjacent one side portion of the sealing portion and the other flap portion being adjacent the other of the side portions of the sealing portion, the sheet being folded around the product such that the inner portion encloses the block-shaped product with the inner surface of the sheet directed towards the product, the inner surfaces of the two side portions of the frame-shaped sealing portion abutting one another to form a longitudinal seal, opposing inner surface regions of the end portions of the frame-shaped sealing portions abutting each other to form seals along respective ends, in which the inner and outer surfaces of the flaps portions are accessible and one of the flap portions is wider than the other, at least part of the longitudinal seal and the flap portions being folded over to one side so that the wider flap portion is positioned underneath the narrower flap portion.

2. A package as claimed in claim 1, in which the inner surface of the wider flap portion that is exposed beyond the outer edge of the narrower flap portion is printed upon.

3. A package as claimed in claim 1 or claim 2 in which at least the longitudinal seal is formed by means of a sealing composition applied to the inner surface of the sheet within the sealing portion.

4. A package as claimed in claim 3, in which the sealing composition is a peelable cold seal adhesive.

5. A package as claimed in claim 3, in which no sealing composition is applied to the flap portions.

6. A package as claimed in claim 3, in which the front and rear seals are formed by welding or otherwise fusing the opposing surfaces of the material

7. A method of packing a generally block-shaped food product by means of a package in accordance with claim 1, the method comprising:
a. positioning the inner surface of the inner portion of the sheet adjacent the food product;
b. folding the sheet around the product so that the product is enclosed by the inner portion of the sheet and the inner surfaces of the side portions of the seal portion are brought into abutment;
c. forming the longitudinal seal along the abutting area;
d. bringing opposing inner surfaces of the end portions of the sealing portion into abutment;
e. forming end seals in the abutting areas;
f. folding the longitudinal seal to one side so as to position the wider flap portion beneath the narrower flap portion.
